(19) United States
(12) Patent Application Publication
(10) Pub. No.: US 2026/0119224 A1
(43) Pub. Date: Apr. 30, 2026

(54) Integrating Virtual Machines into Relational Databases

(71) Applicant: Steven Guilford, Los Angeles, CA (US)

(72) Inventor: Steven Guilford, Los Angeles, CA (US)

(21) Appl. No.: 18/932,612

(22) Filed: Oct. 30, 2024

(51) Int. Cl. G06F 9/455; G06F 16/28

(52) U.S. Cl. CPC G06F 9/45558; G06F 16/284

(57) ABSTRACT

A method is provided comprising enrolling, by a processor, access to a virtual machine disk image in a database for a virtual machine manager by retrieving from the database the parameters required to run a virtual; generating a filename using the retrieved parameters; correlating the filename with the virtual machine disk image; creating a control file from the retrieved parameters; starting the virtual machine virtual machine disk image using the filename; translating, by a processor, the received File I/O requests into Data Operations that perform equivalent File I/O actions on data in a database; executing, by a processor, the Data Operations on the virtual machine disk image in the database, correlated with the filename.

### CROSS REFERENCE TO RELATED APPLICATIONS

This application is a non provisional that claims priority from a provisional U.S. patent application No. 63/594,353 filed on Oct. 30, 2023.

### FIELD OF THE INVENTION

Embodiments of the invention generally relate to databases and file systems. Specifically, embodiments of the invention relate to integrating virtual machines into relational databases.

### BACKGROUND OF THE INVENTION

A database is a collection of data stored in a digital form that can store different types of data ranging from personal identification information to various forms of multimedia. A computer operating system is a collection of programs and components that manage data within a hierarchical file system, executes programs on behalf of a user, interfaces to hardware components and manages the interface between user and the computer. The hierarchical file system is a tree-based, two-dimensional mechanism for storing and managing data (commonly called files) upon a computer hard drive or similar data storage mechanism. A Virtual Disk Image is a representation of a computer hard drive in the form of one or more physical disk files. Virtual disk images can contain operating system code, applications, user data or a combination of all three. A Virtual Machine Manager (VMM) (a.ka. Virtual Machine Monitor, Hypervisor) is software that runs virtual machines. A VMM, commonly called the host, will run a virtual machine, the guest, which is based upon a virtual disk image. Presently, virtual disk images, a form of unstructured data, are usually stored in the legacy, hierarchical file system or in what is frequently called ‘Object Storage. Many relational databases have the ability to store unstructured data (e.g. a virtual disk) as a BLOB (i.e. binary large object)

### SUMMARY

Data is organized more securely in a database than a file system. The present invention leverages the ability of data to be operated upon by external file-based programs that are designed to work on files in a file system while still being able to organize and store data in a database, rather than a file folder hierarchy.

A method is provided comprising enrolling, by a processor, access to a virtual machine disk image in a database for a virtual machine manager by retrieving from the database the parameters required to run a virtual; generating a filename using the retrieved parameters; correlating the filename with the virtual machine disk image; creating a control file from the retrieved parameters; starting the virtual machine virtual machine disk image using the filename; translating, by a processor, the received File I/O requests into Data Operations that perform equivalent File I/O actions on data in a database; executing, by a processor, the Data Operations on the virtual machine disk image in the database, correlated with the filename.

### BRIEF DESCRIPTION OF THE DRAWINGS

The accompanying drawings taken in conjunction with the detailed description will assist in making the advantages and aspects of the disclosure more apparent.

FIG. 1 is a database table layout for the obscure file operations table.

FIG. 2 is a database table layout for the obscure groups table.

FIG. 3 is a flowchart that describes how an obscure file operation is enrolled.

FIG. 4 is a flowchart that describes how an obscure group is created.

FIG. 5 is a flowchart that describes how a ‘get extended attributes’ request is handled.

FIG. 6 is a flowchart that describes a virtual disk image in the database and specifying a proxy filename to the VMM.

FIG. 7 is a flowchart that describes controlling a VMM with the DbPluginServer to access a virtual disk image stored in the database through a gateway provided by DbObscura.

### DETAILED DESCRIPTION

Reference will now be made in detail to the present embodiments discussed herein, illustrated in the accompanying drawings. The embodiments are described below to explain the disclosed method, system, apparatus, and program by referring to the figures using like numerals.

The subject matter is presented in the general context of program modules and/or in computer hardware, including the structures disclosed in this specification and their structural equivalents, or in combinations of one or more of them. Those skilled in the art will recognize that other implementations may be performed in combination with other types of program and hardware modules that may include different data structures, components, or routines that perform similar tasks. The invention can be practiced using various computer system configurations and across one or more computers, including but not limited to clients and servers in a client-server relationship. Computers encompass all kinds of apparatus, devices, and machines for processing data, including by way of example, one or more programmable processors, memory, and can optionally include, in addition to hardware, computer programs and the ability to receive data from or transfer data to, or both, mass storage devices. A computer program, which may also be referred to or described as a program, software, a software application, an app, a module, a software module, a script, or code, can be written in any form of programming language, including compiled or interpreted languages, or declarative or procedural languages; it can be deployed in any form, including as a stand-alone program or as a module, component, subroutine, or other unit suitable for use in a computing environment deployed or executed on one or more computers.

Unless otherwise defined, all terms (including technical and scientific terms) used herein have the same meaning as commonly understood by one having ordinary skill in the art to which this invention belongs. In describing the invention, it will be understood that a number of techniques and steps are disclosed. Each of these has individual benefits, and each can also be used in conjunction with one or more, or in some cases all, of the other disclosed techniques. Accordingly, for the sake of clarity, this description will refrain from repeating every possible combination of the individual steps in an unnecessary fashion. The specification and claims should be read with the understanding that such combinations are entirely within the scope of the invention and the claims.

It will nevertheless be understood that no limitation of the scope is thereby intended, such alterations and further modifications in the illustrated invention, and such further applications of the principles as illustrated therein being contemplated as would normally occur to one skilled in the art to which the embodiments relate. The present disclosure is to be considered as an exemplification of the invention, and is not intended to limit the invention to the specific embodiments illustrated by the figures or description below.

The disclosed invention presents the concept of the Database Operating System (DBOS). A DBOS is a collection of programs, data and logic that merges the capabilities of a hypervisor, a minimal operating system and a relational database. A minimal operating system is described as only those components required to run a relational database without a graphical user interface. A method for accessing a virtual disk image in a database and specifying a proxy filename to the VMM is provided. Further, controlling a VMM with the DbPluginServer to access a virtual disk image stored in the database through a gateway provided by DbObscura is provided.

The disclosed invention leverages Applicant's existing applications, DbPluginServer and DbObscura, to perform disclosed methods. These applications make up part of a larger application which is used to manage and secure unstructured data.

The DbPluginServer allows a user application to interface with a third party technology device via a database. A call of a procedure or function made by a user application is received into an API implemented in a database layer programming language and stored in the database. The database interface API can determine the information to include in a message to be enqueued based on the call received from the user application. The database interface API enqueues a message into a message queue managed by the relational database, a message indicating a function of a third party technology application programming interface. A server-interface program capable of interfacing to the third party technology API receives the message from the message queue and dequeues the message. Then based on the information in the message, the appropriate third party application programming interface function is called. The server interface program can additionally facilitate communication from the third technology API back to the user application indicating the status or confirmation of the third party technology device function call.

DbObscura is an application that exposes data from a database as a file. A requesting user application, that wants to gain/grant access to a resource in the database, identifies the data specifying a function in the database. The function will enroll a filename within the gateway (file interface) and associate the filename with requested data in the database. Because filenames are randomly generated to provide more security, it may be referred to as an obscure file gateway. Once enrolled in the obscure file gateway, file I/O requests of the user application are intercepted and then the necessary actions to satisfy the file I/O requests are performed on the data in the database. Thus, the user application is able to perform, through the obscure file gateway, equivalent read and write requests directly on the data in the database, as it would a file in the file system.

In automated, logically controlled workspace environments, a console program is often used to access secure resources. This console program contains logic that grants user access to secure resources when and if appropriate to the user. The console program will ‘spawn’ an external user program (a cooperative program) to work on file-based data in response to user input. These spawned user programs accept command line arguments to indicate the location of any input or output files. The user program can only operate upon the BLOB data in the database by accessing it as it normally would, as a file. In order to do so, the console program will become a client of a ‘file gateway’ (file interface). The console program will ‘enroll an entry’ (create an entry) in the gateway that allows the external user program to access the BLOB data. The entry in the file gateway correlates a filename with BLOB data in the database.

While not a standard use, additionally, a developer user can directly interface with the file gateway. In such a scenario, the user would act as the interfacing client. The user can directly enroll an entry in the gateway that allows the user to access the BLOB data. The entry in the file gateway correlates a filename with BLOB data in the database.

To add additional security, a new random character filename can be generated each time a user wants to access the data. The obscure filename is used by the user program. Then, when the file is closed, the name can be marked as expired and that name can no longer be used to access the BLOB data. Because the console program normally does not display the command line it uses to spawn the user program, the user cannot find out the filename. In such embodiments, the gateway can be referred to as an ‘obscure file gateway.’ The filename can be completely user specified, completely arbitrary or some combination of the two.

All filenames can be generated in the same directory without any subdirectory specification. Alternatively, subdirectories can be used to separate files for organizational purposes. This enhances security and the ability to audit the use of the file gateway. The filename can include a subdirectory specification that can be completely user specified, completely arbitrary or some combination of the two. For example, the subdirectory can contain user text specified by the program that is interfacing to the file gateway. Such values include, but are not limited to, the process-id, the database session-id, and the host ip-address. The ‘id’ values can be used to further ensure security. For example, process-id security can ensure that the specified process-id matches the process-id or parent-process-id of the client that is opening the file. Another example could require that the session-id refers to an active session in the database. In embodiments that generate a filename without a subdirectory specification, the ‘id’ values can still be encoded on the filename.

In the preferred embodiment, a requesting client may want to gain/grant access to a resource in the database. The client identifies the BLOB by specifying a function in the database that can be called with specific parameter values. The database function returns an object containing the BLOB data to be used by the client. This action is referred to as ‘enrolling a file operation.’

In the preferred embodiment, filenames are randomly generated to provide more security, instead of being created from user supplied text. Therefore the term obscure will appear throughout the description, i.e. ‘enrolling an obscure file operation’ and ‘obscure file gateway.’ The same principles presented apply to a ‘file gateway’ where the user specifies the filename and therefore no limitation is intended. Such embodiments only differ in the generation and handling of the obscure filename, and therefore no limitation is intended.

Additionally, in the preferred embodiment, security checks are set up to confirm that a client user has permission to access a file operation or group of files. This is an additional security feature, and therefore no limitation is intended.

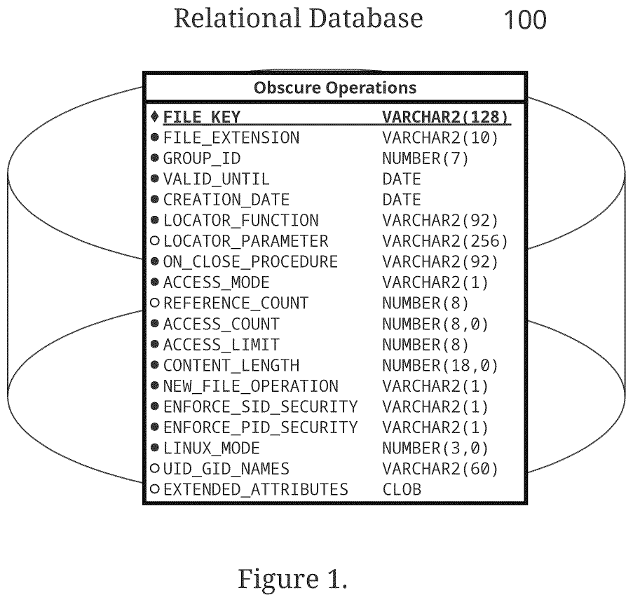

As illustrated in FIG. 1, a database table layout 100 of the obscure file operations table is provided. In the preferred embodiment, the obscure operations table is used to store information about each individual file operation. This OBSCURE_FILE_OPERATIONS table is comprised of the columns: FILE_KEY, FILE_EXTENSION, GROUP_ID, VALID_UNTIL, CREATION_DATE, LOCATOR_FUNCTION, LOCATOR_PARAMETER, ON_CLOSE_PROCEDURE, ACCESS_MODE, REFERENCE_COUNT, ACCESS_COUNT, ACCESS_LIMIT, CONTENT_LENGTH, NEW_FILE_OPERATION, ENFORCE_SID_SECURITY, ENFORCE_PID_SECURITY, ENFORCE_IP_SECURITY, LINUX_MODE, UID_GID_NAMES, and EXTENDED_ATTRIBUTES. FILE_KEY is a unique randomly generated variable length filename used to identify a file operation. FILE_EXTENSION is the file extension associated with the complete filename. GROUP_ID is the group id of the group of files that this file is a part of. VALID_UNTIL is a timestamp that indicates the lifespan of the file operation. Once VALID_UNTIL expires, no further operations are allowed upon the file operation. CREATION_DATE is a timestamp indicating when the obscure file operation was created. LOCATOR_FUNCTION is the name of a database function that when executed will return a BLOB locator variable or an object type that contains a BLOB locator. The function can be contained within a package. LOCATOR_PARAMETER is the value of a parameter, specific to the file operation, which will be included when calling the locator function. ON_CLOSE_PROCEDURE is the name of a database procedure that will be executed when closing a file. ACCESS_MODE indicates whether the file operations allow read only, write only or read-write access to the file. Valid values are ‘R’, ‘W’, and ‘U’ respectively. REFERENCE_COUNT indicates the number of current references (open calls) associated with the file key. ACCESS_COUNT indicates the total number of times that the file key has been opened. ACCESS LIMIT specifies a limit to the number of times a file can be opened. CONTENT_LENGTH is the length of the BLOB data. The value is utilized in read and read-write operations. NEW_FILE_OPERATION is a flag value which indicates that the obscure entry correlates to a new file. ENFORCE_SID_SECURITY is a flag value which indicates if database session-id security will be enforced for this obscure file operation. ENFORCE_PID_SECURITY is a flag value which indicates if system process-id security will be enforced for this obscure file operation. ENCORCE_IP_SECURITY is a flag value which indicates if ip-address security will be enforced for this obscure file operation. The default value for NEW_FILE_OPERATION, ENFORCE_SID_SECURITY, ENFORCE_PID_SECURITY, ENFORCE_IP_SECURITY is ‘N.’ The LINUX_MODE column indicates the associated ‘linux mode bit’ settings for the file The default value for LINUX_MODE is 600. The UID_GID_NAMES column, formatted as ‘user group’, indicates the user and the group names of the user that owns the obscure file. The EXTENDED_ATTRIBUTES column stores any ‘extended attributes’ that are associated with the file. The default value for UID_GID_NAMES and EXTENDED_ATTRIBUTES is null.

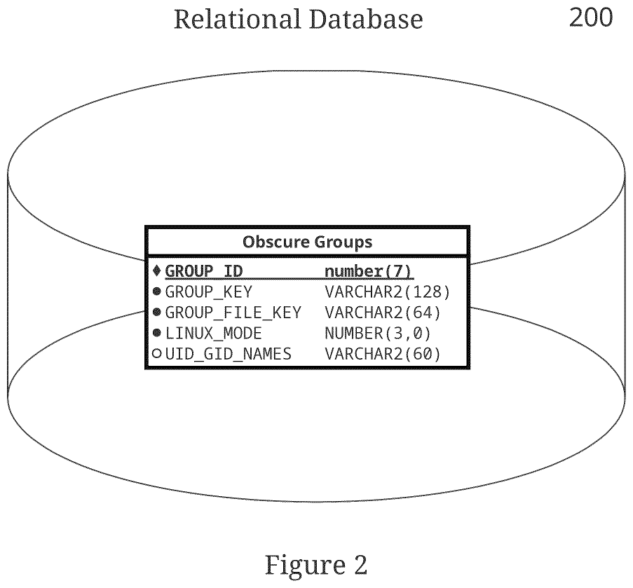

As illustrated in FIG. 2, a database table layout 200 of the obscure groups table is provided. It may be beneficial to organize related files into groups using subdirectories. In such embodiments, the obscure groups table is used to store information about groups of files. This OBSCURE_FILE_OPERATIONS table is comprised of the columns: GROUP_ID, GROUP_KEY, and GROUP_FILE_KEY, LINUX_MODE, and UID_GID_NAMES. GROUP_ID is an ID value that uniquely identifies the group and which can be used in relational data references. GROUP_KEY is the subdirectory specification. GROUP_FILE_KEY is the root of all file names that will be generated for files enrolled within the obscure group. The LINUX_MODE column indicates the associated ‘linux mode bit’ settings for the subdirectory. The default value for LINUX_MODE is 600. The UID_GID_NAMES column, formatted as ‘user:group’, indicates the user and the group names of the user that owns the obscure subdirectory. The default value for UID_GID_NAMES is null.

The obscure file gateway API exists as a package and user-defined data types stored in the database. These objects provide functions, constants and data types that are used by client programs that interact with the obscure file gateway. For a simple enrollment of a single file, the client makes a call to a function in the obscure file gateway API. The function will enroll a filename within the gateway and associate the filename with a BLOB in the DB. The obscure file interface will return the filename, or in embodiments which use the obscure groups table, the obscure file interface will return the concatenated value of the group key and the filename.

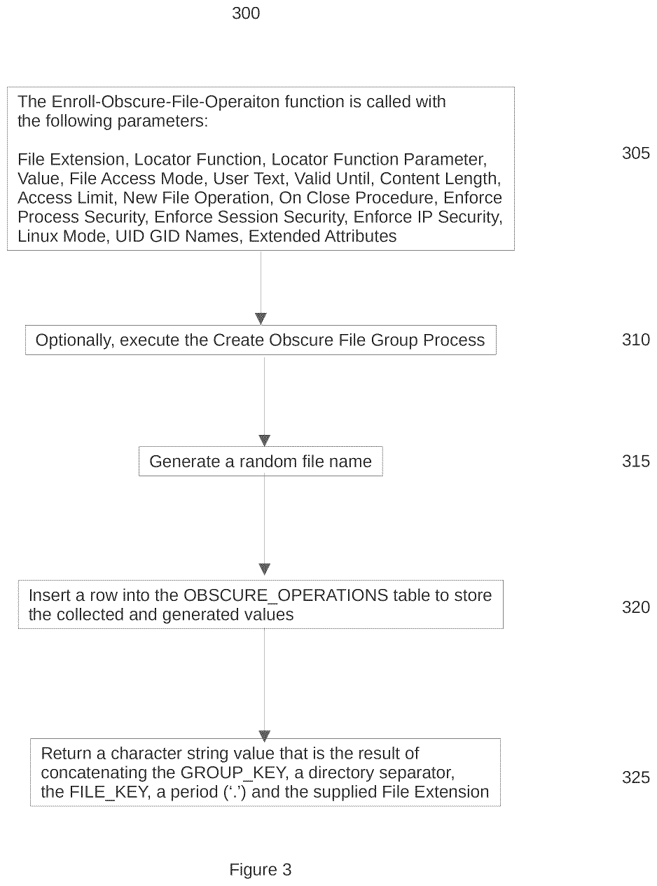

As illustrated in FIG. 3, a flowchart 300 of the Enroll Obscure File operation, detailing how an obscure file operation is enrolled, is provided. The parameter values passed to the function are the File Extension, Locator Function, Locator Function Parameter Value, File Access Mode, User Text, Valid Until, Content Length, Access Limit, New File Operation, On Close Procedure, Enforce Process-ID Security, Enforce Session-ID Security, Enforce IP-address Security, Linux Mode, UID GID Names, and Extended Attributes 305. File Extension is the file extension to be applied to the generated filename. Locator Function specifies the database function that, when called, will return a BLOB object. Locator Function Parameter Value is used when calling the Locator Function. Access Mode indicates the mode of file operation. For example, access mode may indicate the file can be opened for read-only. User Text is user supplied text that will be used, in embodiments that create a subdirectory, when building a subdirectory. Valid Until indicates the file operation expiration date/time. Content Length indicates the BLOB's length. Access Limit, an optional value, indicates the number of times to allow a file ‘open’ operation. The default is to allow one file access operation. Setting the value to −1 allows an unlimited number of file access operations. New File Operation, an optional value, indicates that the obscure file operation corresponds to a file that will be created anew. This allows the obscure entry to be mapped to the associated BLOB for use when the file is created. However, it also prevents the ‘get attributes’ file I/O function from seeing the ‘new file operation’ entry. On Close Procedure, an optional value, specifies a database procedure that will be called upon closing the obscure file entry. This allows application logic to take specific actions upon the closing of a file. Enforce Process-ID Security, an optional value, indicates whether the client will enforce system process id security upon the program making use of the gateway. Enforce Session-ID Security, an optional value, indicates whether the client will ensure the database session security when satisfying the gateway request. Enforce IP-address Security, an optional value, indicates whether the file system module will enforce client IP address security before satisfying the gateway request. The LINUX_MODE for the file parameter indicates the associated ‘linux mode bit’ settings for the file. The UID_GID_NAMES for the file parameter formatted as ‘user: group’, indicates the user and the group names of the user that owns the obscure file. The EXTENDED_ATTRIBUTES column stores any ‘extended attributes’ that are associated with the file.

In embodiments utilizing an obscure groups table, the enrollment process executes the Create Obscure File Group process to create a group for the single file operation 310. The process ID, IP address and DB session ID of the client that is enrolling the obscure file operation can be retrieved by the API from the database. In addition to the User Text parameter value, the process ID, IP address, and DB session ID can be used when building the subdirectory specification to add an additional layer of security, in embodiments that create a subdirectory. A filename of random characters is generated 315. In other embodiments, the filename can be created using user specified input or user specified input combined with random characters. This user text can include system process ID, user's IP address, database username, and user's database session ID if available. A row is inserted in the OBSCURE_FILE_OPERATIONS table to store the collected and generated values 320. The row's column values of FILE_EXTENSION, LOCATOR_FUNCTION, LOCATOR_PARAMETER, ACCESS_MODE, VALID_UNTIL, CONTENT_LENGTH, ACCESS_LIMIT, NEW_FILE_OPERATION, ON_CLOSE_PROCEDURE, ENFORCE_PID_SECURITY, ENFORCE_SID_SECURITY, ENFORCE_IP_SECURITY are set respectively with the passed values File Extension, Locator Function, Locator Function Parameter Value, File Access Mode, Valid Until, Content Length, Access Limit, New File Operation, On Close Procedure, Enforce Process-ID Security, Enforce Session-ID Security, and Enforce IP-address Security. The row's column values of FILE_KEY and GROUP_KEY are set respectively with the generated random filename and the group key. The function returns a character string value that is the result of concatenating the GROUP_KEY (if GROUP_KEY exists), a directory separator (if GROUP_KEY exists), the FILE_KEY, a period ‘.’ character and the supplied File Extension 325. The client can then use the generated filename by spawning an associated program and/or by specifying the filename in the course of its processing, such as when it issues file I/O calls.

In some situations, an external user program will opens multiple files at a time within the same directory. While a subdirectory is optional in instances of a single file operation, the implementation to create a subdirectory for a group of files is extremely useful. For enrollment of multiple files within a group (subdirectory), a group is created with the obscure file gateway first. The obscure file gateway returns the group key to the client. The application will then specify the group when enrolling the files. The client is then able to operate on each file located within the subdirectory.

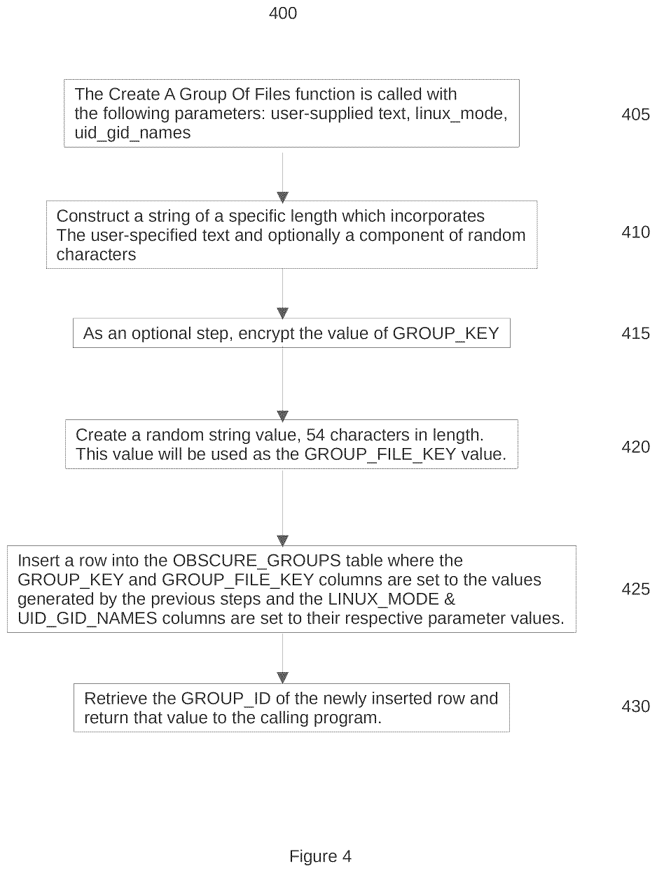

As illustrated in FIG. 4, a flowchart 400 of the Create Obscure File Group operation, detailing how an obscure group is created, is provided. The parameter values passed to the function are the User-supplied Text, Linux Mode and UID GID Names 405. This user-supplied text is incorporated into the Group Key. The LINUX_MODE for the subdirectory parameter indicates the associated ‘linux mode bit’ settings for the subdirectory. The UID_GID_NAMES for the subdirectory parameter formatted as ‘user group’, indicates the user and the group names of the user that owns the obscure subdirectory. The system process ID, IP address and DB session ID of the client that is enrolling the obscure file operation can be retrieved by the API from the database. In addition to the User-supplied Text parameter value, the process ID, IP address and DB session ID can be incorporated into the Group Key to add an additional layer of security. A string of a specific length is created incorporating the User-supplied Text, system process ID, user's IP address, database username, and user's database session ID if available 410. A portion of the string may also be made up of random characters.

A sample encoding, where each component is separated by two dollar sign ‘$’ characters, is provided:
random text$$client ip address$$client process id$$database session id$$database username$$client supplied text.

An actual example is provided:
‘5g67v$$192.168.1.15$$1224$$293969$$MEDIA$$live_project’.

Optionally, the Group Key value can be encrypted to provide more security 415. This value will be used as the Group Key. A random string value 54 characters in length is created which will be used as the Group File Key 420. The Group File Key will be used as the basis for generated filenames within the obscure group. A row is inserted in the OBSCURE_GROUPS table to store the generated values 425. The row's column values of GROUP_KEY, GROUP_FILE_KEY are set respectively with the recently generated values Group Key and Group File Key. The row's column values of LINUX_MODE and UID_GID_NAMES are set to their respect parameter values. The GROUP_ID of the newly inserted row is retrieved and returned to the calling program 430.

Some operating systems provide a mechanism whereby a loadable file-system module, written by a systems programmer skilled in the art, can intercept (or otherwise receive) the file I/O requests of a user program. The file-system module can intercept the file I/O requests of the user program and then perform the actions necessary to satisfy them. This provides an extreme degree of flexibility in the design of a system that satisfies I/O calls. Traditionally, the OS reads and writes data from the specified location on the hard drive. By intercepting OS file read and write requests, the present embodiment of the invention allows one to instead read and write to the database.

For example, Linux has a virtual file-system API which provides a framework that simplifies the writing of a loadable file-system module. It utilizes a dedicated mount point within the Linux file system. When a file I/O request comes in for a file located within the mount point, the OS forwards the file I/O operation on to the user written virtual file-system. The virtual file-system takes whatever actions are necessary to satisfy the I/O request.

In the preferred embodiment, the file I/O operations that have been received and handled accordingly are open file, read file, write file, close file, get file/extended attributes, flush buffered data, open directory, read directory, and close directory.

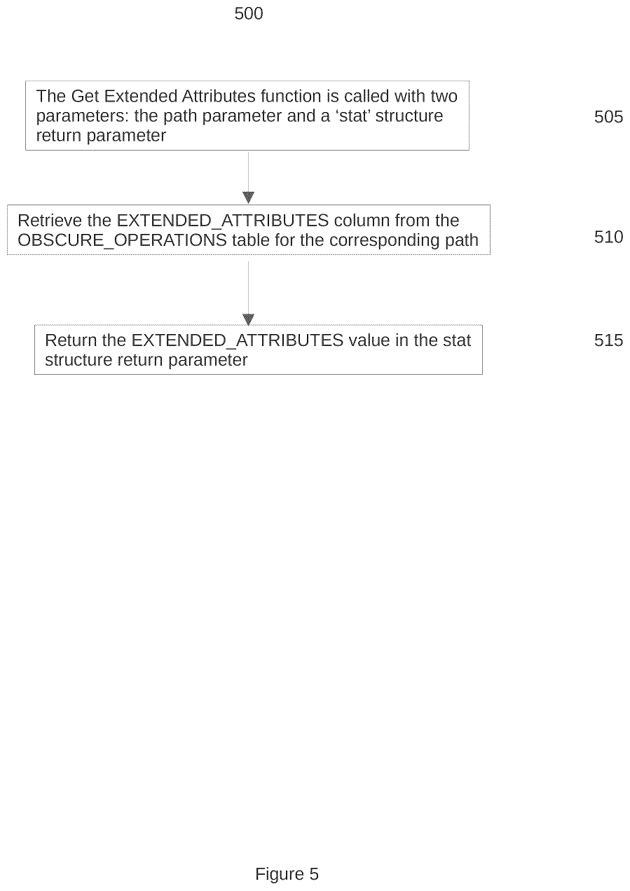

As illustrated in FIG. 5, a flowchart 500 of the Get Extended Attributes operation, detailing how a ‘get extended attributes’ request on a file is handled, is provided. The parameters received from the file system are the file path and a ‘stat’ structure. The ‘stat’ structure is used to return attribute values to the OS. The file path is parsed to identify the file name 505. The OBSCURE_FILE_OPERATIONS table is queried to select the row where the FILE_KEY corresponds to the specified filename to retrieve the column value in EXTENDED_ATTRIBUTES 510. The EXTENDED ATTRIBUTE value is returned in the stat structure 515.

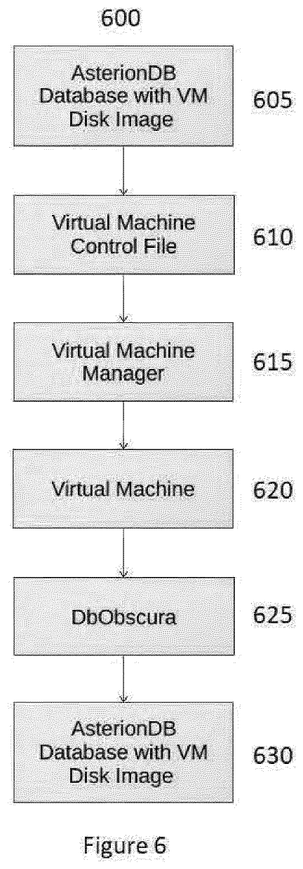

As illustrated in FIG. 6, a virtual disk image is stored in the database using DBObscura. DBObscura exposes the virtual disk image by generating a proxy filename that can be used by associated technology called DbObscura. The VMM has a control file, or a similar mechanism, where the proxy filename for the virtual disk image can be specified. The VMM then runs the virtual machine using the proxy filename that is assigned to the virtual disk image. This process can be triggered from the command line using a VM Manager utility program and appropriate parameter

A virtual disk image for a virtual machine is stored in the database 605. The parameters to run a virtual machine are retrieved from the database and a filename is generated. The filename is correlated with the virtual machine disk image and a virtual machine control file from the retrieved parameters is created. Virtual machine control file 610 points to the virtual disk image using a filename which has been generated and enrolled into DBObscura. The virtual machine manager 615 starts the virtual machine using the control file which references a virtual machine disk image stored in the database. The virtual machine 620 uses the filename enrolled in DbObscura and recorded in the virtual machine control file to interact with the virtual machine disk image. DbObscura 625 uses the enrolled filename to satisfy the file I/O requests made by the virtual machine by referencing the virtual disk image stored in the database. Virtual disk image stored within the database 630, accessed by DbObscura to satisfy I/O on behalf of the virtual machine.

The following code segment shows the major steps required to create and start a virtual machine utilizing the following functions:

vm_manager.create_virtual_disk - creates a disk-image from a seed-image.
vm_manager.create_cloud_init_cdrom_image - creates a CDROM image with cloud-init data
vm_manager.create_virtual_machine - interacts with the VM manager to create and start a VM
machine
vm_manager.start_virtual_machine - interacts with the VM Manager to start a virtual machine
(from an existing VM disk image).
declare

| | |
|---|---|
| l_virtual_disk_id | virtual_machines.virtual_disk_id%type; |
| l_object_id | vault_objects.object_id%type; |
| l_authorized_ssh_keys | json_array_t := json_array_t; |
| l_dns_nameservers | json_array_t := json_array_t; |
| l_dns_search | json_array_t := json_array_t; |
| l_vm_id | virtual_machines.vm_id%type; |

```
begin
  l_virtual_disk_id := vm_manager.create_virtual_disk(p_user_id => 172, p_disk_image_name
=> ‘woody-test.qcow2’, p_seed_image_id => ‘8P8FNDG1UT4W04RI33OPZKANF0B0B2TJ’);
  l_authorized_ssh_keys.append(‘ssh-rsa AAAAB3Nz....user@xyz.com’);
  l_authorized_ssh_keys.append(‘ssh-rsa AAAAB3NzaC1y....user@xyz.com’);
  l_dns_nameservers.append(‘192.168.1.15’);
  l_dns_search.append(‘company.local’);
  l_dns_search.append(‘company.com’);
  l_object_id := vm_manager.create_cloud_init_cdrom_image(172, ‘test’, ‘test.company.local’,
‘user’, l_authorized_ssh_keys, ‘virbr0’,
    ‘192.168.1.20’, ‘192.168.1.254’, ‘255.255.255.0’, l_dns_nameservers, l_dns_search);
  dbms_output.put_line(l_object_id);
  l_vm_id := vm_manager.create_virtual_machine(p_user_id => 172, p_machine_name =>
‘woody-test’, p_virtual_disk_id => l_virtual_disk_id, p_virtual_cdrom_id => l_object_id,
    p_os_variant => ‘xxx.xxx’, p_vcpu_count => 2, p_virtual_memory => 2048,
p_network_source => ‘bridge’, p_network_device => ‘virbr0’);
end;
```

The following code segment how one interacts with the dbObscura API to specify the mode-bits and the uid:gid values:

l_virtual_disk_filename := digital_bunker.generate_object_filename(p_object_id =>
l_virtual_machine.virtual_disk_id,
p_gateway_name => s_plugin_process.get_string(‘pluginServer’), p_access_mode =>
dbobscura_api.READ_WRITE_ACCESS,
p_linux_file_mode => 600, p_linux_subdir_mode => 705, p_disable_stream_write => ‘Y’,
p_access_limit => dbobscura_api.unlimited_access_operations, p_valid_until =>
restapi.NO_EXPIRATION,
p_file_user_group => ‘root:root’, p_subdir_user_group => ‘root:root’);

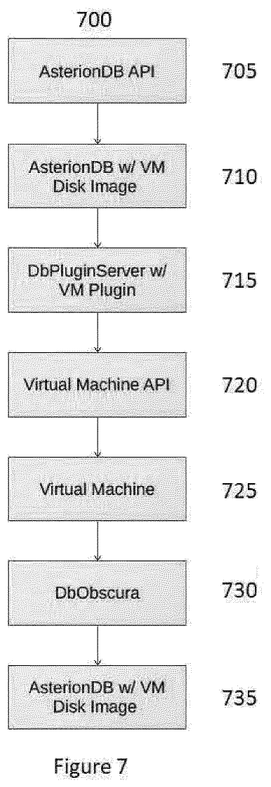

Incorporating further concepts from FIG. 6, a method of controlling the VMM is provided. As illustrated in FIG. 7, a database plugin called the DbPluginServer (or a mechanism based upon the inter-database process communication capabilities embodied by the DbPluginServer) will interface with the VMM to enable the direct control and manipulation of the VMM that will access virtual disks through a gateway provided by DBObscura.

The API 705 receives a request to start a virtual machine. A filename is generated, for use by DbObscura, that points to a virtual disk image stored within the database 710. A Virtual Machine Plugin running upon the DbPluginServer 715 receives a request to start a virtual machine. The Plugin interacts with the virtual machine API 720 to start a virtual machine that references the enrolled filename for a virtual disk image stored in the database. The virtual machine 725 interacts with DbObscura to access the virtual disk image. DbObscura 730 receives data I/O requests from the virtual machine. DbObscura satisfies the virtual disk image I/O requests by accessing the virtual disk image stored within the database 735.

The preceding description contains embodiments of the invention, and no limitation of the scope is thereby intended. It will be further apparent to those skilled in the art that various modifications and variations can be made in the present invention without departing from the spirit or scope of the invention.

1. (canceled)

2. A method comprising:
enrolling, by a processor, access to a virtual machine disk image in a database for a virtual machine manager by:
a) retrieving from the database the parameters required to run a virtual machine;
b) generating a filename using the retrieved parameters;
c) correlating the filename with the virtual machine disk image;
d) creating a control file from the retrieved parameters;
starting the virtual machine disk image using the filename;
translating, by a processor, the received File I/O requests into Data Operations that perform equivalent File I/O actions on data in a database;
executing, by a processor, the Data Operations on the virtual machine disk image in the database, correlated with the filename.

3. A method of claim 2 further comprising:
first, spawning, by a processor, a user program that accesses file-based data;
wherein the received File I/O Requests are from the user program.

4. The method of claim 2 further comprising:
after correlating the filename with the virtual machine disk image, restricting use of the filename to access the virtual machine disk image after a specific date.

5. The method of claim 2 further comprising:
after correlating the filename with the virtual machine disk image, restricting use of the filename to access the virtual machine disk image after the virtual machine disk image has been accessed a specific number of times.

6. The method of claim 2, wherein the generated filename includes a subdirectory specification.

7. The method of claim 2, wherein the filename is generated from user supplied text.

8. The method of claim 2, wherein the filename is randomly generated.

9. The method of claim 2, wherein the filename is a combination of user supplied text and randomly generated characters.

10. The method of claim 2, wherein a database session ID is used to generate the filename;
and further comprising:
after receiving File I/O requests, checking, by a processor, that the database session ID encoded in the filename matches an active session ID.

11. The method of claim 2, where in a system process ID is used to generate the filename;
and further comprising:
after receiving File I/O requests, checking, by a processor, that the system process ID encoded in the filename matches an active client system process ID or group ID.
